(19) United States
(12) Patent Application Publication
(10) Pub. No.: US 2014/0287284 A1
(43) Pub. Date: Sep. 25, 2014

(54) COOLING SYSTEM FOR VEHICULAR BATTERY

(71) Applicant: Keisuke Shibata, Miyoshi-shi (JP)

(72) Inventor: Keisuke Shibata, Miyoshi-shi (JP)

(73) Assignee: TOYOTA JIDOSHA KABUSHIKI KAISHA, Toyota-shi, Aichi-ken (JP)

(21) Appl. No.: 14/358,458

(22) PCT Filed: Nov. 15, 2012
(86) PCT No.: PCT/IB2012/002354

§ 371 Date: May 15, 2014

(30) Foreign Application Priority Data
Nov. 17, 2011 (JP) 2011-251777

(51) Int. Cl. H01M 10/6568; H01M 10/613

(52) U.S. Cl. CPC H01M 10/5077; H01M 10/5004
USPC 429/72

(57) ABSTRACT

A cooling system for a vehicular battery of a vehicle is provided with a radiator, and at least one water pump that includes a first water pump. The first water pump cools the vehicular battery by circulating coolant between the vehicular battery and the radiator. The first water pump is arranged in a position that is lower than the vehicular battery or in a position that is at the same height as the vehicular battery. The vehicular battery is arranged in a position that is lower than the radiator.

### BACKGROUND OF THE INVENTION

1. Field of the Invention

The invention relates to a cooling system for a vehicular battery of a vehicle.

2. Description of the Related Art

A vehicular battery that supplies electric power to a motor or a motor-generator or the like that serves as a power source is mounted in hybrid vehicles and electric vehicles and the like. A battery that is capable of charging and discharging electric power, for example, may be used as the vehicular battery. The battery generates heat when charging and discharging electric power. Therefore, when the temperature of the battery becomes high from heat generation, the performance of the battery may decline, and the battery may deteriorate. As a result, the possible power storage capacity of the battery may decrease, and the life of the battery may become shorter.

Japanese Patent Application Publication No. 2002-352866 (JP 2002-352866 A) proposes a water-cooling type cooling system that efficiently cools a battery by circulating coolant between the battery and a radiator using a water pump.

With the kind of water-cooling type cooling system described above, coolant is circulated along a path from a battery 110→a first water pump 130, a radiator 120, a second water pump 140 (see FIG. 7)→the battery 110, as shown in FIG. 6, for example. The battery 110 that serves as the vehicular battery is arranged under a floor of the vehicle (i.e., below a floor panel 160), for example, due to limited mounting space. In this case, as shown in FIG. 6, when the first water pump 130 is arranged in a position higher than the battery 110, a phenomenon such as that described below may occur.

That is, the pressure of the coolant (i.e., the pressure in the path) that flows out from a coolant discharge port 113 of the battery 110 decreases before the coolant reaches an intake port 131 of the first water pump 130, so a cavitation phenomenon may occur inside the first water pump 130. This will be described in detail below.

The battery 110 has a plurality of battery cells, not shown, that are stacked and electrically connected together in series inside a battery case 111, for example. Also, a coolant passage for circulating the coolant is formed between adjacent battery cells inside the battery case 111. However, adjacent battery cells are arranged with a slight gap therebetween inside the battery case 111, so only a small sectional area is able to be ensured as the sectional area of the coolant passage. As a result, a pressure loss inside of the battery 110 becomes greater than a pressure loss inside of the radiator 120.

Also, as shown in FIG. 7, for example, a pressure P113 of the coolant at the coolant discharge port 113 of the battery 110 is lower than a pressure P112 of the coolant at a coolant inlet, not shown, of the battery 110. In addition to this, when the first water pump 130 is arranged in a position higher than the battery 110, the pressure of the coolant will decrease by the amount that the potential energy of the coolant increases, before the coolant reaches the intake port 131 of the first water pump 130 from the coolant discharge port 113 of the battery 110. Also, a pressure P131 of the coolant at the intake port 131 of the first water pump 130 that is arranged downstream of the battery 110 may be the lowest pressure in the path of the cooling system. In the example illustrated in FIGS. 6 and 7, the pressure P131 of the coolant that reaches the intake port 131 of the first water pump 130 has decreased by a pressure ΔP (FIG. 7) corresponding to the potential energy of a difference in height ΔH1 (FIG. 6) between the battery 110 and the first water pump 130.

Also, when coolant that has decreased in pressure flows into the first water pump 130, the cavitation phenomenon may occur near an impeller portion of the first water pump 130. Therefore, in a battery cooling system, the discharge rate of the first water pump 130 must be set such that this cavitation phenomenon will not occur at the impeller portion inside the first water pump 130.

### SUMMARY OF THE INVENTION

The invention provides a cooling system for a vehicular battery of a vehicle, that is capable of inhibiting the occurrence of a cavitation phenomenon inside a water pump.

One aspect of the invention relates to a cooling system for a vehicular battery of a vehicle. This cooling system is provided with a radiator, and at least one water pump that includes a first water pump. The first water pump cools the vehicular battery by circulating coolant between the vehicular battery and the radiator. The first water pump is arranged in a position that is lower than the vehicular battery or in a position that is at the same height as the vehicular battery. At least a portion of the vehicular battery is arranged in a position that is lower than the radiator.

Here, when arranging the water pump (i.e., the first water pump) in a position that is at the same height as the vehicular battery, the height position of the water pump with respect to the vehicular battery simply need be set such that at least a portion of a range (i.e., a region) from an upper end to a lower end of the water pump overlaps with a portion of a range (i.e., a region) from an upper end to a lower end of the vehicular battery, in the vertical direction. More preferably, the height position of the water pump with respect to the vehicular battery need simply be set such that the entire range from the upper end to the lower end of the water pump is included in the range from the upper end to the lower end of the vehicular battery, in the vertical direction.

Also, when arranging the water pump in a position that is lower than the vehicular battery, the height position of the water pump with respect to the vehicular battery need simply be set such that the upper end of the water pump is lower than the lower end of the vehicular battery.

On the other hand, when arranging the vehicular battery in a position that is lower than the radiator, the height position of the vehicular battery with respect to the radiator need simply be set such that the lower end of the vehicular battery is provided in a position that is at least lower than the lower end of the radiator.

According to this structure, the water pump is arranged in a position that is lower than the vehicular battery or in a position that is at the same height as the vehicular battery, so the pressure of the coolant that flows out from a coolant discharge port of the vehicular battery is inhibited from decreasing before the coolant reaches an intake port of the water pump, and thus the cavitation phenomenon can be inhibited from occurring inside the water pump. Making it more difficult for the cavitation phenomenon to occur inside the water pump in this way makes it possible to increase the discharge rate of the water pump. As a result, according to this structure, in the cooling system, the cooling efficiency of the vehicular battery can be improved from what it is in the cooling system according to the related art.

In the cooling system described above, the radiator may be arranged in a grill of the vehicle, and the vehicular battery and the first water pump may be arranged below a floor of the vehicle.

According to this structure, the coolant inside of the radiator, i.e., the coolant that has been increased in temperature by heat exchange with the vehicular battery, can be efficiently cooled by running wind that is taken in through the grill portion when the vehicle is running.

In the cooling system having the structure described above, the first water pump may be arranged downstream of the vehicular battery, and arranged upstream of the radiator. In the cooling system having this structure, a second water pump may be provided upstream of the vehicular battery and downstream of the radiator.

In the cooling system having the structure described above, the first water pump may be housed in a case of the vehicular battery.

According to this structure, the water pump is covered by the case of the vehicular battery, so the water pump is able to be prevented from becoming chipped, and covered in mud and water and the like. Also, compared with when the water pump is provided outside the vehicular battery, the coolant circulating passage that connects the intake port of the water pump to the coolant discharge port of the vehicular battery can be shortened or omitted, so the overall cooling system can be made smaller, and moreover, the brackets or the like for fixing the vehicular battery and the water pump below the floor can also be made smaller.

In the cooling system having the structure described above, the vehicular battery may be a battery capable of charging and discharging electric power. Also in the cooling system having the structure described above, the vehicle may be a hybrid vehicle or an electric vehicle, and may be provided with a motor, as a power source, that is supplied with electric power from the vehicular battery.

In the cooling system having the structure described above, at least a portion of the first water pump may be arranged in a position that is lower than the vehicular battery.

In the cooling system having the structure described above, the entire first water pump may be arranged in a position that is lower than the vehicular battery.

In the cooling system having the structure described above, the entire vehicular battery may be arranged in the position that is lower than the radiator.

According to the cooling system for a vehicular battery of a vehicle of the invention, the water pump is arranged in a position that is lower than the vehicular battery or in a position that is at the same height as the vehicular battery, so the pressure of the coolant that flows out from the coolant discharge port of the vehicular battery is inhibited from decreasing before the coolant reaches the intake port of the water pump. As a result, the cavitation phenomenon is able to be inhibited from occurring inside the water pump. Making it more difficult for the cavitation phenomenon to occur inside the water pump in this way makes it possible to increase the discharge rate of the water pump.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a view showing a frame format of one example of a cooling system for a vehicular battery of a vehicle according to one example embodiment of the invention;

FIG. 2 is a side view of one example of an arrangement of the vehicular battery, a radiator, and a first water pump of the cooling system in FIG. 1 in a vehicle;

FIG. 3 is a sectional view taken along line X1-X1 (i.e., as viewed from the X1-X1 direction) in FIG. 2 of the vehicular battery, the first water pump, and a floor panel;

FIG. 4 is a graph showing a change in pressure of coolant inside a path of the cooling system shown in FIG. 1;

FIG. 5 is a side view showing a modified example in which the first water pump is housed inside a case of the vehicular battery;

FIG. 6 is a view corresponding to FIG. 2, that shows an arrangement of a vehicular battery, a radiator, and a water pump of a cooling system according to related art; and

FIG. 7 is a view corresponding to FIG. 4, that shows a change in pressure of coolant inside of a path of the cooling system according to the related art.

### DETAILED DESCRIPTION OF EMBODIMENTS

Example embodiments of the invention will now be described in detail with reference to the accompanying drawings.

In these example embodiments, an example will be described in which the invention has been applied to a cooling system for a vehicular battery mounted in a hybrid vehicle. The hybrid vehicle is provided with, as power sources, an internal combustion engine such as a gasoline engine or a diesel engine, and a motor that is supplied with electric power from a vehicular battery. The invention may of course also be applied to a cooling system for a vehicular battery mounted in an electric vehicle that is provided with only a motor as a power source.

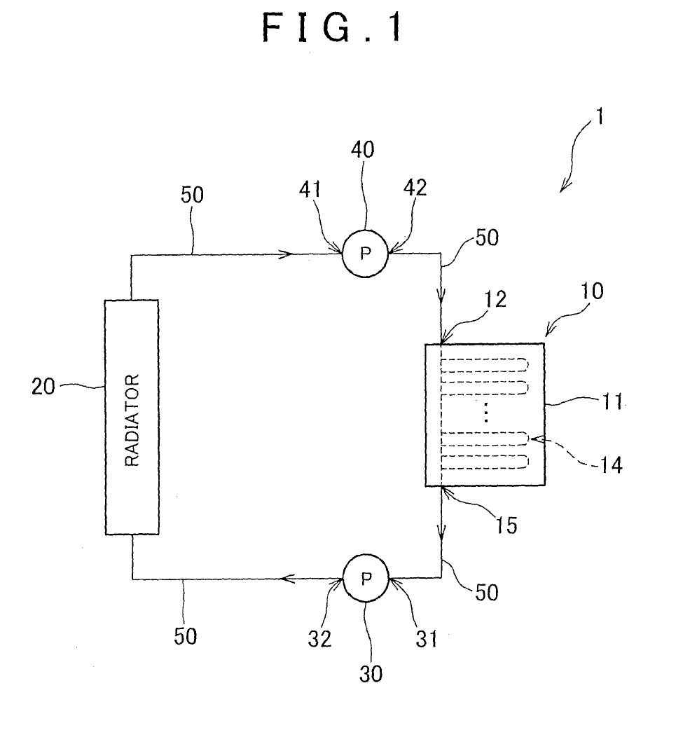

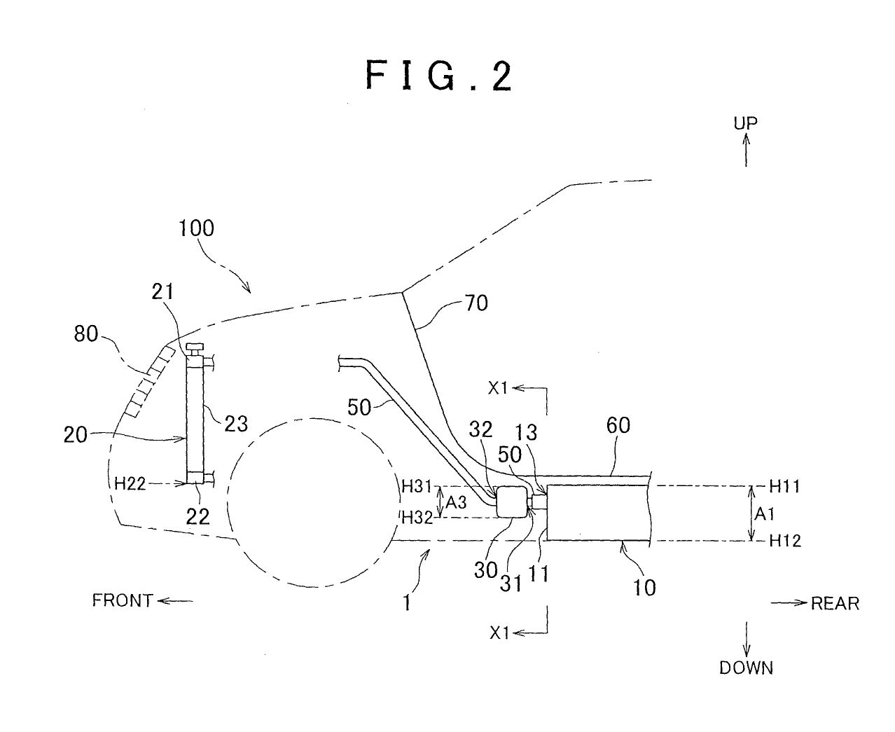

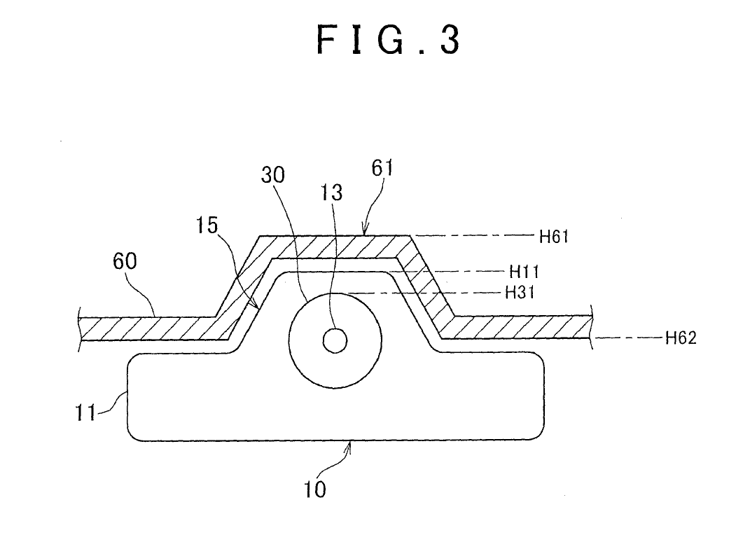

FIG. 1 is a view showing a frame format of an example of a cooling system for a vehicular battery of a vehicle according to one example embodiment of the invention. FIG. 2 is a side view of one example of an arrangement of the vehicular battery, a radiator, and a first water pump of the cooling system in FIG. 1 in a vehicle, and FIG. 3 is a sectional view taken along line X1-X1 (i.e., as viewed from the X1-X1 direction) in FIG. 2 of the vehicular battery, the first water pump, and a floor panel.

As shown in FIG. 1, a cooling system 1 of a battery 10 that serves as a vehicular battery (this cooling system may also simply be referred to as “cooling system 1”) includes a radiator 20, a first water pump 30, a second water pump 40, and a coolant circulating passage (coolant conduit) 50 that connects these devices together. With this cooling system 1, coolant is circulated between the battery 10 and the radiator 20 by the first water pump 30 and the second water pump 40. More specifically, in the cooling system 1, coolant is circulated along a path from the battery 10→the first water pump 30→the radiator 20→the second water pump 40 the battery 10.

The battery 10 includes a battery case 11 and a plurality of battery cells, not shown, for example. The battery case 11 has a generally rectangular parallelepiped shape. The plurality of battery cells are housed inside of this battery case 11. Each battery cell is formed in a thin plate shape with a generally rectangular parallelepiped shape. The plurality of battery cells are arranged stacked inside of the battery case 11, and are electrically connected together in series by a bus bar or the like, not shown. The battery cells are formed by lithium-ion batteries, for example. The battery cells are not particularly limited as long s they are secondary cells capable of charging and discharging electric power. For example, the battery cells may be nickel-metal-hydride batteries.

Inside of the battery case 11, a coolant passage 14 (indicated by the broken lines in FIG. 1) through which coolant flows is formed between the battery case 11 and the battery cells, as well as between adjacent battery cells. Also, a coolant inlet (an inlet) 12 for introducing coolant into the coolant passage 14 inside of the battery case 11, and a coolant discharge port (an outlet) 13 for discharging coolant from the coolant passage 14 inside the battery case 11, are formed in the battery case 11. Also, the battery 10 that increases in temperature as it charges and discharges is cooled by coolant flowing through the coolant passage 14 inside of the battery case 11.

The coolant inlet 12 is connected via the coolant circulating passage 50 to a discharge port (an outlet) 42 of the second water pump 40 that is arranged upstream of the battery 10. The coolant discharge port 13 is connected via the coolant circulating passage 50 to an intake port (an inlet) 31 of the first water pump 30 that is arranged downstream of the battery 10.

The radiator 20 is a down flow type radiator, for example, and includes a radiator core 23 between an upper tank 21 and a lower tank 22, as shown in FIG. 2. When coolant that has flowed into the upper tank 21 on the inlet side flows down through the radiator core 23 toward the lower tank 22 on the outlet side, heat is radiated to the outside air by heat exchange between this coolant and the outside air (i.e., airflow created when the vehicle runs (hereinafter referred to as “running wind”) that is introduced through a grill portion (grill) 80, or air blown by a cooling fan being driven), such that the coolant is cooled. The upper tank 21 of the radiator 20 is connected via the coolant circulating passage 50 to a discharge port (an outlet) 32 of the first water pump 30 that is arranged upstream of the radiator 20. The lower tank 22 is connected via the coolant circulating passage 50 to an intake port (an inlet) 41 of the second water pump 40 that is arranged downstream of the radiator 20.

The first water pump 30 and the second water pump 40 are both electric water pumps. The rotation speeds of the first water pump 30 and the second water pump 40 are each controlled by a control unit, not shown. Accordingly, the discharge rates (i.e., the discharge pressures) of the coolant of the first water pump 30 and the second water pump 40 are each able to be variably controlled.

In this example embodiment, as shown in FIG. 2, the battery 10 and the first water pump 30 are arranged under a floor of a vehicle 100, i.e., under a floor panel 60. The battery 10 and the first water pump 30 are supported by the floor panel 60 by brackets or the like, not shown. The battery 10 is arranged upstream of the first water pump 30 in the direction in which coolant flows, and the coolant circulating passage 50 from the battery 10 to the first water pump 30 extends substantially horizontally.

More specifically, as shown in FIG. 3, when viewed from a vehicle longitudinal direction (i.e., in the left-right direction in FIG. 2), the battery 10 (i.e., the battery case 11) is shaped such that a center portion 15 thereof in a vehicle width direction (i.e., the left-right direction in FIG. 3) protrudes upward, and this center portion 15 extends in the vehicle longitudinal direction. The floor panel 60 is also similarly shaped such that a center portion 61 thereof in the vehicle width direction protrudes upward, and this center portion 61 extends in the vehicle longitudinal direction. Also, the center portion 15 of the battery 10 is housed in a space (i.e., a floor tunnel) below the center portion 61 of the floor panel 60. Also, the first water pump 30 is arranged in front of the center portion 15 of the battery 10. In this case, an upper end H11 of the battery 10 is arranged in a position that is lower than an upper end H61 of the floor panel 60 (i.e., an upper end H61 of the center portion 61). Also, an upper end H31 of the first water pump 30 is also arranged in a position that is lower than the upper end H61 of the floor panel 60.

As shown in FIG. 2, the radiator 20 is arranged in front of a dash panel 70 of the vehicle 100, and is provided on the grill portion 80 of the frontmost end portion of the vehicle 100. Also, when the vehicle 100 is running, the coolant inside the radiator core 23 of the radiator 20, i.e., the coolant that increases in temperature from heat exchange with the battery 10, is cooled by the running wind that is taken in through the grill portion 80. The coolant circulating passage 50 from the first water pump 30 to the upper tank 21 of the radiator 20 extends upward at an angle.

Also, in this example embodiment, as shown in FIG. 2, the battery 10 is arranged in a position that is lower than the radiator 20. More specifically, an upper end H11 of the battery 10 is provided in a position that is lower than a lower end H22 of the lower tank 22 of the radiator 20.

Further, in this example embodiment, the first water pump 30 is arranged in a position that is at the same height as the battery 10. More specifically, an entire range (a region) A3 from an upper end H31 to a lower end H32 of the first water pump 30 is included within a range (a region) A1 from the upper end H11 to a lower end H12 of the battery 10, in the vertical direction (i.e., in the vertical direction in FIG. 2).

In the vehicle 100, the relationships among the height positions of the battery 10, the radiator 20, and the first water pump 30 of the cooling system 1 are set as described below, so effects such as those described below are able to be obtained.

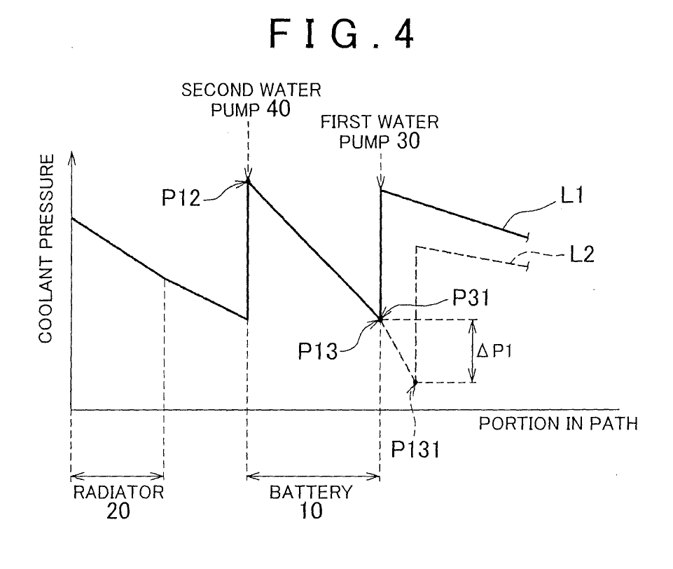

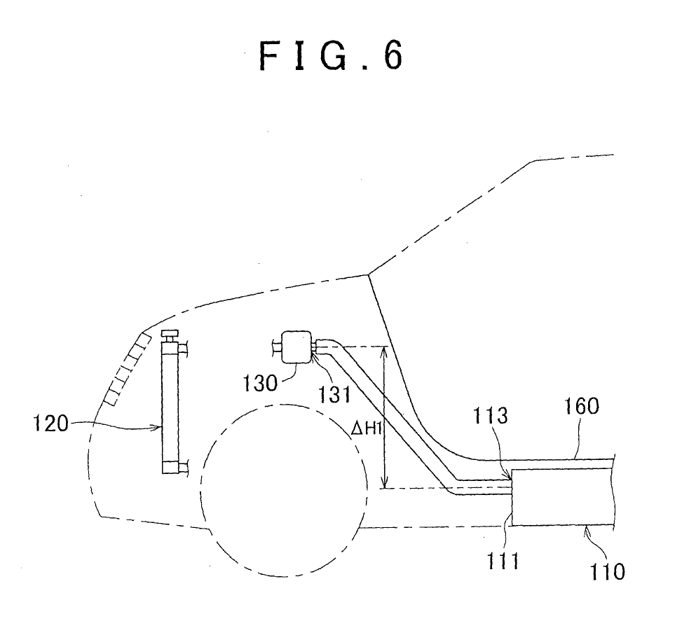

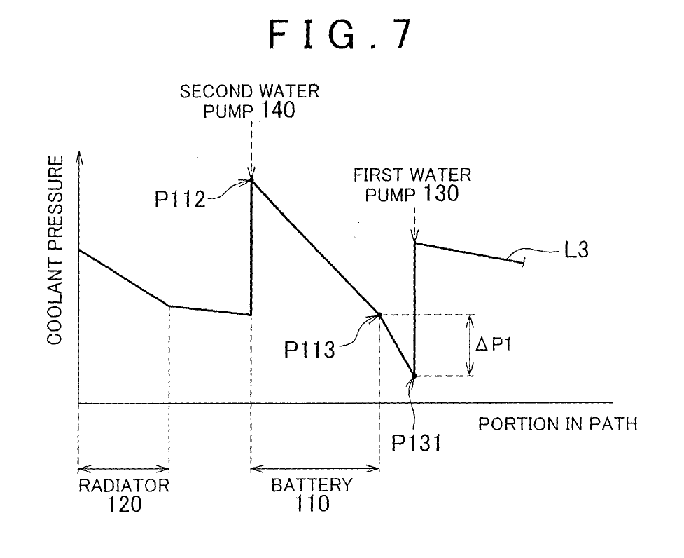

That is, the first water pump 30 is arranged in a position that is at the same height as the battery 10, so the pressure (i.e., the pressure in the path) of the coolant that flows out from the coolant discharge port 13 of the battery 10 is inhibited from decreasing before the coolant reaches the intake port 31 of the first water pump 30. Therefore, the cavitation phenomenon can be inhibited from occurring inside the first water pump 30. As a result, a decrease in the discharge rate of the first water pump 30 due to the cavitation phenomenon can be inhibited. This will be described with reference to FIG. 4. In FIG. 4, a change in the pressure of the coolant in the path of the cooling system 1 according to this example embodiment is indicated by the solid line L1, and a change (only a portion is shown) in the pressure of the coolant in the path of a cooling system according to related art (see FIG. 6, for example) is indicated by the broken line L2. The change in the pressure of the coolant shown by the broken line L2 in FIG. 4 is the same as the change in the pressure of the coolant shown by the solid line L3 in FIG. 7.

As shown in FIG. 4, the pressure of the coolant discharged from the first water pump 30 and the second water pump 40 gradually decreases due to loss in the battery 10, loss in the radiator 20, and loss in the coolant circulating passage 50 and the like, in the path of the cooling system 1. The first water pump 30 and the second water pump 40 serve to increase the pressure of the coolant that decreases in the path (i.e., to compensate for this decrease)

As described above already, the loss in the battery 10 is greater than the loss in the radiator 20 and the loss in the coolant circulating passage 50, so the pressure P13 of the coolant at the coolant discharge port 13 of the battery 10 is lower than the pressure P12 of the coolant at the coolant inlet 12. Also, the pressure P31 of the coolant at the intake port 31 of the first water pump 30 that is arranged downstream of the battery 10 may be the lowest pressure in the path of the cooling system 1.

However, in the cooling system according to the related art (see FIG. 6), the first water pump 130 is arranged in a position higher than the battery 110. Therefore, as shown by the broken line L2 in FIG. 4, the pressure of the coolant has decreased by ΔP1, corresponding to the amount that the potential energy of the coolant increases, before the coolant reaches the intake port 131 of the first water pump 130 from the coolant discharge port 113 of the battery 110.

In contrast, in this example embodiment, as shown in FIG. 2, the first water pump 30 is arranged in a position that is at the same height as the battery 10. Therefore, as shown by the solid line L1 in FIG. 4, in the cooling system 1, the potential energy of the coolant will not increase before the coolant reaches the intake port 31 of the first water pump 30 from the coolant discharge port 13 of the battery 10, so a decrease in the pressure of the coolant is able to be suppressed more than can be is in the cooling system according to the related art.

Therefore, in this example embodiment, as shown in FIG. 4, the lowest pressure in the path of the cooling system 1, in this case, the pressure P31 of the coolant at the intake port 31 of the first water pump 30, is able to be higher by ΔP1 than it is in the cooling system according to the related art. Here, in the cooling system 1, when the first water pump 30 is provided in a position that is lower by ΔH1 (see FIG. 6, for example) than it is in the cooling system according to the related art, the relationship [ΔP1=ρg ΔH1] is satisfied (where ρ is the density of the coolant, and g is a gravitational constant).

Also in this example embodiment, the pressure P31 of the coolant at the intake port 31 of the first water pump 30 is higher by ΔP1 than it is in the cooling system according to the related art, so the cavitation phenomenon is able to be inhibited from occurring inside the first water pump 30. Making it more difficult for the cavitation phenomenon to occur inside the first water pump 30 in this way makes it possible to increase the discharge rate of the first water pump 30. As a result, according to this example embodiment, in the cooling system 1, the cooling efficiency of the battery 10 can be improved from what it is in the cooling system according to the related art.

### Other Example Embodiments

The invention is not limited to the example embodiment described above. To the contrary, all modifications and applications that are within the scope of the claims for patent and within a scope equivalent to the scope of these claims are possible.

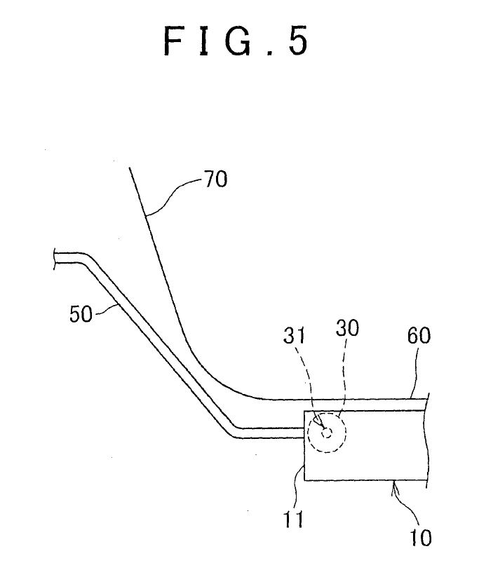

In the example embodiment described above, the first water pump 30 is arranged on the outside of the battery 10 (see FIG. 2), but the invention is not limited to this. That is, the first water pump 30 may also be mounted inside the battery case 11 of the battery 10. A modified example of this will be described with reference to FIG. 5.

As shown in FIG. 5, the first water pump 30 is housed inside the battery case 11 of the battery 10. Also, the intake port 31 of the first water pump 30 is connected to a discharge portion, not shown, of a coolant passage provided inside of the battery case 11.

According to this modified example, the first water pump 30 is covered by the battery, case 11, so the first water pump 30 is able to be prevented from becoming chipped, and covered in mud and water and the like. Also, compared with when the first water pump 30 is provided outside the battery 10 (see FIG. 2), the coolant circulating passage 50 that connects the intake port 31 of the first water pump 30 to the discharge portion of the coolant passage can be shortened or omitted, so the overall cooling system 1 can be made smaller, and moreover, the brackets or the like for fixing the battery 10 and the first water pump 30 to the floor panel 60 can also be made smaller.

The height relationships among the battery 10, the radiator 20, and the first water pump 30 of the cooling system 1 described above are only examples, and may be modified as described below, for example.

In the example embodiment described above, the entire range A3 from the upper end H31 to the lower end H32 of the first water pump 30 is included within the range A1 from the upper end H11 to the lower end H12 of the battery 10, in the vertical direction. However, the invention is not limited to this. That is, the height position of the first water pump 30 with respect to the battery 10 may be changed as long as at least a portion of the range A3 from the upper end H31 to the lower end H32 of the first water pump 30 overlaps with a portion of the range A1 from the upper end H11 to the lower end H12 of the battery 10, in the vertical direction.

Also, in the example embodiment described above, the first water pump 30 is arranged in a position that is at the same height as the battery 10, but the first water pump 30 may also be arranged in a position that is lower than the battery 10. In this case, the height position of the first water pump 30 with respect to the battery 10 may be set such that the upper end H31 of the first water pump 30 is lower than the lower end H12 of the battery 10.

As long as a height position relationship between the battery 10 and the first water pump 30 such as that described above is satisfied, the first water pump 30 may also be located somewhere other than below the floor of the vehicle 100.

Also, in the example embodiment described above, the upper end H11 of the battery 10 is provided in a position that is lower than the lower end H22 of the lower tank 22 of the radiator 20. However, the invention is not limited to this. That is, the height position of the battery 10 with respect to the radiator 20 may be changed as long as the lower end H12 of the battery 10 is provided in a position that is at least lower than the lower end H22 of the lower tank 22 of the radiator 20.

The structures of the battery 10 described above and the cooling system 1 illustrated in FIG. 1 are merely examples. Other structures may also be employed. For example, the second water pump 40 may be omitted and only the first water pump 30 may be provided in the cooling system. Also, a coolant passage that cools a motor or an inverter or the like, and a reservoir or the like, may be provided in the cooling system.

The shapes of the floor panel 60 and the battery 10 illustrated in FIG. 3 are merely examples. Other shapes may also be employed. Also, the height position relationships among the battery 10, the first water pump 30, and the floor panel 60 are only examples. Other structures may also be employed. For example, the upper end H11 of the battery 10, and the upper end H31 of the first water pump 30 may be arranged in positions lower than a lower end H62 of the floor panel 60.

The vehicular battery is not limited to only a battery such as that described above, but may also be a fuel cell or the like. That is, the invention is not limited to only a hybrid vehicle or an electric vehicle, as long as the vehicle is provided with a motor, as a power source, that is supplied with electric power from a vehicular battery. For example, the invention may also be applied to a fuel cell vehicle or the like.

The invention is able to be used for a water-cooling type cooling system that cools a vehicular battery by circulating coolant between the vehicular battery and a radiator using a water pump, in a vehicle provided with a motor, as a power source, that is supplied with electric power from the vehicular battery.

1. A cooling system for a vehicular battery of a vehicle, comprising:
a radiator; and
at least one water pump including a first water pump, the first water pump cooling the vehicular battery by circulating coolant between the vehicular battery and the radiator; the first water pump being arranged in a position that is lower than the vehicular battery or in a position that is at the same height as the vehicular battery; and at least a portion of the vehicular battery being arranged in a position that is lower than the radiator, wherein the radiator is arranged in a grill of the vehicle, and the vehicular battery and the first water pump are arranged below a floor of the vehicle.

2. (canceled)

3. The cooling system according to claim 1, wherein the first water pump is arranged downstream of the vehicular battery, and arranged upstream of the radiator.

4. The cooling system according to claim 3, wherein a second water pump is provided upstream of the vehicular battery and downstream of the radiator.

5. The cooling system according to claim 3, wherein the first water pump is housed in a case of the vehicular battery.

6. The cooling system according to claim 1, wherein the vehicular battery is a battery capable of charging and discharging electric power.

7. The cooling system according to claim 1, wherein the vehicle is a hybrid vehicle or an electric vehicle, and is provided with a motor, as a power source, that is supplied with electric power from the vehicular battery.

8. The cooling system according to claim 1, wherein at least a portion of the first water pump is arranged in the position that is lower than the vehicular battery.

9. The cooling system according to claim 1, wherein the entire first water pump is arranged in the position that is lower than the vehicular battery.

10. The cooling system according to claim 1, wherein the entire vehicular battery is arranged in the position that is lower than the radiator.
